(19) United States
(12) Patent Application Publication
(10) Pub. No.: US 2003/0028446 A1
(43) Pub. Date: Feb. 6, 2003

(54) Web-enabled method and system for searching correct model data indicative of a porduct to be purchased online

(76) Inventors: Stephen Akers, Crestwood, KY (US); Michael Starmer, Louisville, KY (US)

Correspondence Address: John S Beulick, Armstrong Teasdale LLP, One Metropolitan Square, Suite 2600, St Louis, MO, 63102, US

(21) Appl. No.: 09/742,533

(22) Filed: Dec. 22, 2000

(51) Int. Cl. G06F 17/60

(52) U.S. Cl. 705/27

(57) ABSTRACT

A web-enabled method for processing an order transmitted to a site by a purchaser to enable purchase of a product is provided. The method provides a web page order including at least a data field to be filled by the purchaser with model data indicative of a product to be purchased. The data field is actually filled with incorrect model data. The web page with the incorrect model data is transmitted to the site. The purchaser is informed that the transmitted web page includes incorrect model data. A clickable hyperlink is provided to the purchaser to execute a search of correct model data based on the incorrect model data. A window on the web page order is displayed and includes a list of respective correct model data. A respective hyperlink with each respective model data included in the list is provided so that upon any respective hyperlink being clicked by the purchaser, the data field in the web page order is automatically filled with the correct model data corresponding to that hyperlink.

### BACKGROUND OF THE INVENTION

The present invention is generally related to computerized method and system for managing electronic data, and, more particularly, the present invention is related to web-enabled method and system for processing an order transmitted to a site by a purchaser to enable purchase of a product.

Known techniques for purchasing products through the Internet are generally premised on the fact that the purchaser knows how to identify the product to be purchased. In some industries, however, due to their competitive nature and/or demands of consumers, new product models may be frequently introduced over a relatively short period of time. Printed materials, such as price sheets including model data for respective products, provided to the purchaser may be outdated in a short period of time. Thus, at the time of making an order of new products, the purchaser may have to spend valuable time to be able to correctly identify any new models that may have been recently introduced in the market place. Since such industries may handle a large volume and variety of consumer goods, including appliance goods, home office computer equipment, entertainment electronic equipment, etc, the aggregate impact to the national economy due to any incremental time needed to place the order is significant. Although searching techniques may be presently available, such techniques may not necessarily be user-friendly since in many instances they require a relatively large number of actions by the user and such techniques may not necessarily provide a focused search conducive to reduce the amount of time spent by the user in order to successfully complete an online transaction.

In view of the foregoing, it would be desirable to provide a user-friendly tool able to reduce the number of steps it would take the purchaser to find a correct model data of a product based on incorrect model data initially entered by the purchaser.

### BRIEF SUMMARY OF THE INVENTION

Generally speaking, the present invention fulfills the foregoing needs by providing in one aspect thereof a web-enabled method for processing an order transmitted to a site by a purchaser to enable purchase of a product. The method provides a web page order including at least a data field to be filled by the purchaser with model data indicative of a product to be purchased. The data field is actually filled with incorrect model data. The web page with the incorrect model data is transmitted to the site. The purchaser is informed that the transmitted web page includes incorrect model data. A clickable hyperlink is provided to the purchaser to execute a search of correct model data based on the incorrect model data. A window on the web page order is displayed and includes a list of respective correct model data. A respective hyperlink with each respective model data included in the list is provided so that upon any respective hyperlink being clicked by the purchaser, the data field in the web page order is automatically filled with the correct model data corresponding to that hyperlink.

The present invention further fulfills the foregoing needs by providing in another aspect thereof a web-enabled system for processing an order transmitted to a site by a purchaser to enable purchase of a product. The system includes a module configured to provide a web page order including at least a data field to be filled by the purchaser with model data indicative of a product to be purchased. The data field is actually filled with incorrect model data. A module is configured to inform the purchaser that the data field includes incorrect model data. A database that includes correct model data is provided. A hyperlink clickable by the purchaser to execute a search of correct model data is provided. The search is executed in the database based on the incorrect model data. A module is configured to generate a window on the web page order including a list of respective correct model data and wherein each respective model data in the list includes a respective hyperlink so that upon any respective hyperlink being clicked by the purchaser, the data field in the web page order is automatically filled with the correct model data corresponding to that hyperlink.

### DESCRIPTION OF THE DRAWINGS

FIG. 1 is a schematic of an exemplary web-enabled system that may be used for practicing one embodiment of the present invention.

FIG. 2 is a flow chart illustrating exemplary steps of a method for processing an order transmitted to a site by a purchaser to enable purchase of a product,

FIG. 3 is an exemplary Web page order including a data field to be completed with model data indicative of a product to be purchased;

FIG. 4 illustrates the Web page order of FIG. 3 completed with exemplary incorrect model data, and further illustrates a window including a list including exemplary correct model data, such as may be obtained upon the purchaser executing a search in accordance with one aspect of the present invention.

### DETAILED DESCRIPTION OF THE INVENTION

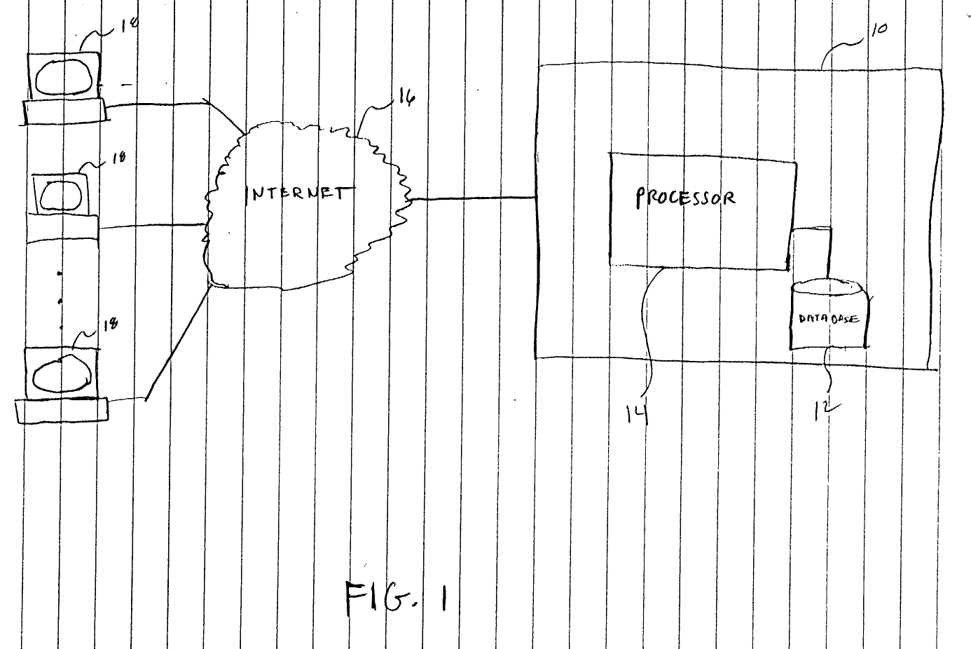

FIG. 1 is a schematic representation of an exemplary web-enabled system that may be used for processing an order transmitted to a site by a purchaser to enable purchase of a product. The site may be operated and managed by the assignee of the present invention. By way of example, the site may comprise a server 10 made up of a database 12 coupled to a processor 14 that processes in respective processing modules electronic data configured to enable online commercial transactions over a suitable telecommunications medium, such as a web-enabled communications medium 16. A telecommunications device 18, such as a computer loaded with any commercially available web browser may be used by the purchaser, as described below in greater detail, to download web pages from server 10 and to transmit data back to server 10. It will be appreciated that the site and the purchasers are generally remote relative to one another.

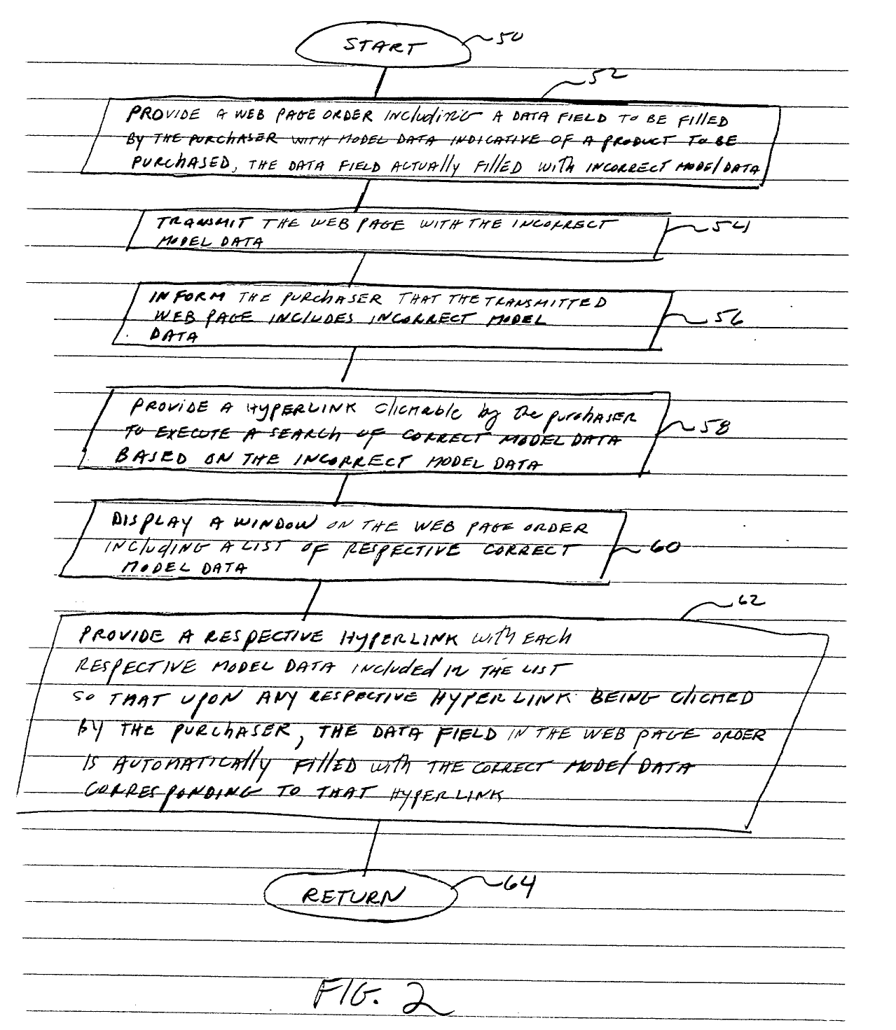

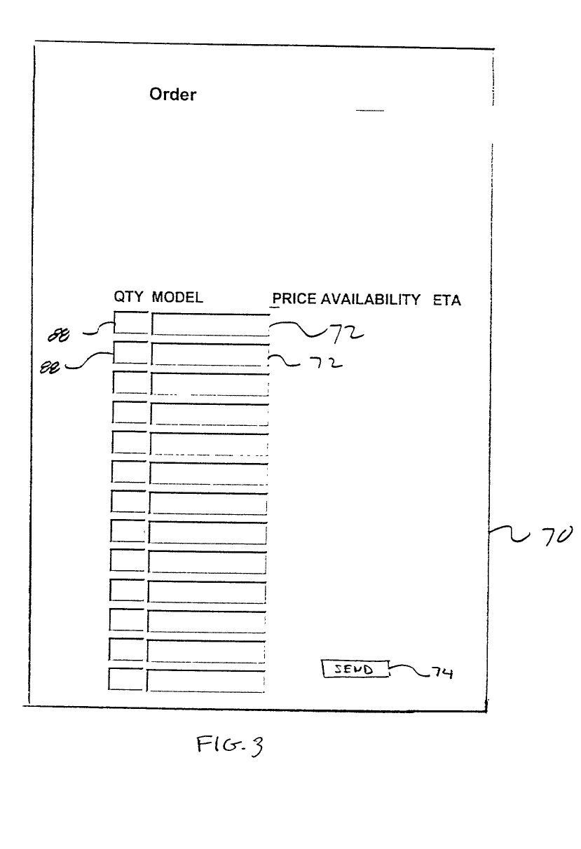

FIG. 2 is a flow chart illustrating exemplary steps of a web-enabled method in accordance with one aspect of the present invention. The web-enabled method allows for processing an order transmitted to the site by a purchaser to enable purchase of a product. Subsequent to start step 50, step 52 allows for providing a web page order 70 (FIG. 3) including a data field 72 to be filled by the purchaser with model data indicative of a product to be purchased. As suggested above, data field 72 may be actually filled with incorrect model data. For example, the purchaser may remember the first two characters of a product model data to include the letters “GS” but the purchaser does not remember a third letter used to identify the product, and thus the third letter is left out by the purchaser.

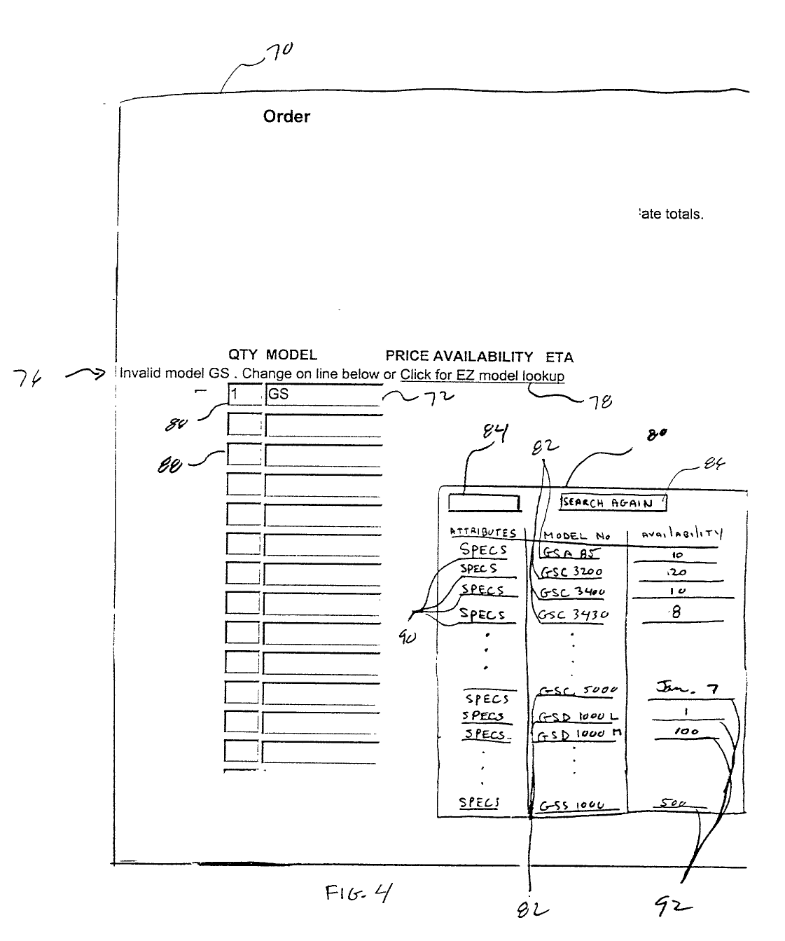

Step 54 allows for transmitting web page 70 filled with incorrect model data to the site. Step 56 allows for informing the purchaser that the transmitted web page includes incorrect model data. As shown in FIG. 4, a message 76 is displayed on web page 70 indicating that the letters “GS” do not match correct product model data. At this point in the process, the purchaser has the option of either correcting the incorrect data on data field 72 or clicking a provided hyperlink 78, (FIG. 4) identified to the purchaser with any straight forward instruction, such as “Click for EZ model lookup” or similar instruction. As shown at step 58, the provided hyperlink 78 is clickable by the purchaser to execute a search of correct model data based on the incorrect model data. Step 60 allows for displaying a window 80 (FIG. 4) on web page 70 including a list of respective correct model data. For example, as shown in FIG. 4, assuming that due to the omission of the third letter, the incorrect model data entered by the purchaser were the letters “GS”, then the search results would include each model designation that includes the letters “GS”. For example, assuming correct model data includes respective families of products designated as GSA, GSC, GSD, through GSS, then each member of such families of product models including the letters “GS” would be listed in one or more pages that may be scrolled by the purchaser in window 80. Step 62 allows for providing a respective hyperlink 82 associated with each respective model data included in the list so that upon any respective hyperlink being clicked by the purchaser, data field 72 in web page order 72 would be automatically filled with the correct model data corresponding to that hyperlink.

For example, if the product that the purchaser desires to purchase is identified by model data GSA85, then the purchaser would click the hyperlink directly below model data GSA85 and once that respective hyperlink is clicked, then datafield 72 would automatically change from “GS” to “GSA85” and the purchaser would continue to fill in any other information necessary to complete the transaction, such as account number, method of payment, destination, desired date of delivery, etc. In the event that the results of the initial search provide a relatively large number of hits, web page order 70 further includes a search field 84 (FIG. 4) configurable by the purchaser to execute a narrower search based on the list including correct model data. For example, the purchaser, upon review of the results of the initial search, remembers that the third letter of the model data is the letter “C”, then the purchaser could enter in search field 84, the letters “GSC” and upon clicking hyperlink 86 another search would be executed to list each model data that is member of the GSC family of products. It will be appreciated that further searching could be performed by the purchaser, in the event further narrowing of any intermediate search results were needed. In one exemplary embodiment, the searching technique is sufficiently flexible to match correct model data regardless of the position of any incorrect entry relative to the correct model data. Assuming that the model data entered by the purchaser is “GSD2030HWW”, wherein the letter H prior to letters WW represents an incorrect entry. In this case, a searching pattern including all the correct alphanumeric characters would be created, and the incorrect entry, in this case the letter H would be stripped and filled in with other entries until obtaining a match with correct model data. Thus, assuming correct model data respectively includes designations GSD2030FWW and GSD2030ZWW, then the search results would display both designations of correct model data regardless of the fact that in one case the correct letter, e.g., letter F, precedes the incorrect letter, e.g., letter H, and in the other case the correct letter, e.g., letter Z occurs after the incorrect letter, e.g., letter H. It will be appreciated that the same searching technique would work equally effective with numbers in lieu of letters.

As shown in FIGS. 3 and 4, another data field, e.g., data field 88, is used to indicate the quantity of products corresponding to a given model number that the purchaser desires to purchase. As shown in FIG. 4, the listed model data may further include respective hyperlinks 90 and 92 that may be clicked by the purchaser to obtain various product attributes, such as product specification, product price, etc., or product availability, such as the number of products presently available, or expected date of availability.

The present invention can be embodied in the form of computer-implemented processes and apparatus for practicing those processes. The present invention can also be embodied in the form of computer program code containing computer-readable instructions embodied in tangible media, such as floppy diskettes, CDROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code segments configure the computer to create specific logic circuits or processing modules.

It will be understood that the specific embodiment of the invention shown and described herein is exemplary only. Numerous variations, changes, substitutions and equivalents will now occur to those skilled in the art without departing from the spirit and scope of the present invention. Accordingly, it is intended that all subject matter described herein and shown in the accompanying drawings be regarded as illustrative only and not in a limiting sense and that the scope of the invention be solely determined by the appended claims.

What is claimed is:

1. A web-enabled method for processing an order transmitted to a site by a purchaser to enable purchase of a product, the method comprising:
providing a web page order including at least a data field to be filled by the purchaser with model data indicative of a product to be purchased, said data field actually filled with incorrect model data;
transmitting the web page with the incorrect model data to the site;
informing the purchaser that the transmitted web page includes incorrect model data;
providing a hyperlink clickable by the purchaser to execute a search of correct model data based on the incorrect model data;
displaying a window on the web page order including a list of respective correct model data; and
providing a respective hyperlink with each respective model data included in the list so that upon any respective hyperlink being clicked by the purchaser, the data field in the web page order is automatically filled with the correct model data corresponding to that hyperlink.

2. The web-enabled method of claim 1 wherein the web page order further includes a search field configurable by the purchaser to execute a narrower search based on the list including correct model data.

3. The web-enabled method of claim 1 wherein the web page order further includes another data field indicative of the quantity of products to be ordered.

4. The web-enabled method of claim 1 wherein the listed model data further includes product availability.

5. The web-enabled method of claim 4 wherein the listed model data further includes a product attribute.

6. The web-enabled method of claim 5 wherein the product attribute comprises specification data.

7. A web-enabled method for processing an order transmitted to a site by a purchaser to enable purchase of a product, the method comprising:
providing a web page order including at least a data field to be filled by the purchaser with model data indicative of a product to be purchased, said data field actually filled with incorrect model data;
transmitting the web page with the incorrect model data to the site;
informing the purchaser that the transmitted web page includes incorrect model data;
providing a hyperlink clickable by the purchaser to execute a search of correct model data based on the incorrect model data;
displaying a window on the web page order including a list of respective correct model data, and wherein the displayed window further includes a search field configurable by the purchaser to execute a narrower search based on the list including correct model data; and
providing a respective hyperlink with each respective model data included in the list so that upon any respective hyperlink being clicked by the purchaser, the data field in the web page order is automatically filled with the correct model data corresponding to that hyperlink;

8. The web-enabled method of claim 7 wherein the web page order further includes another data field indicative of the quantity of products to be ordered.

9. The web-enabled method of claim 7 wherein the listed model data further includes product availability.

10. The web-enabled method of claim 9 wherein the listed model data further includes a product attribute.

11. The web-enabled method of claim 7 wherein the product attribute comprises specification data.

12. A computer-readable medium encoded with computer program code for processing an order transmitted to a web site by a purchaser to enable purchase of a product, the program code causing a computer to execute a method comprising:
providing a web page order including at least a data field to be filled by the purchaser with model data indicative of a product to be purchased, said data field actually filled with incorrect model data;
transmitting the web page with the incorrect model data to the site;
informing the purchaser that the transmitted web page includes incorrect model data;
providing a hyperlink clickable by the purchaser to execute a search of correct model data based on the incorrect model data;
displaying a window on the web page order including a list of respective correct model data; and
providing a respective hyperlink with each respective model data included in the list so that upon any respective hyperlink being clicked by the purchaser, the data field in the web page order is automatically filled with the correct model data corresponding to that hyperlink.

13. The computer-readable medium of claim 12 wherein the web page order further includes a search field configurable by the purchaser to execute a narrower search based on the list including correct model data.

14. The computer-readable medium of claim 12 wherein the listed model data further includes product availability.

15. The computer-readable medium of claim 12 wherein the listed model data further includes a product attribute.

16. A web-enabled system for processing an order transmitted to a site by a purchaser to enable purchase of a product, the system comprising:
a module configured to provide a web page order including at least a data field to be filled by the purchaser with model data indicative of a product to be purchased, said data field actually filled with incorrect model data;
a module configured to inform the purchaser that the data field includes incorrect model data;
a database configured to store correct model data;
a hyperlink clickable by the purchaser to execute a search of correct model data in said database based on the incorrect model data;
a module configured to generate a window on the web page order including a list of respective correct model data and wherein each respective model data in the list includes a respective hyperlink so that upon any respective hyperlink being clicked by the purchaser, the data field in the web page order is automatically filled with the correct model data corresponding to that hyperlink.

17. The system of claim 16 wherein the web page order further includes a search field configurable by the purchaser to execute a narrower search based on the list including correct model data.

18. The system of claim 16 wherein the web page order further includes another data field indicative of the quantity of products to be ordered.

19. The system of claim 16 wherein the listed model data further includes product availability.

20. The system of claim 19 wherein the listed model data further includes a product attribute.

21. The system of claim 20 wherein the product attribute comprises specification data.

22. A web-enabled method for processing an order transmitted to a site by a purchaser to enable purchase of a product, the method comprising:
providing a web page order including at least a data field to be filled by the purchaser with model data indicative of a product to be purchased, said data field actually filled with incorrect model data;
transmitting the web page with the incorrect model data to the site;
informing the purchaser that the transmitted web page includes incorrect model data;
providing a hyperlink clickable by the purchaser to execute a first search of correct model data based on the incorrect model data;
displaying a window on the web page order including a first list of respective correct model data;
providing a search field configurable to execute a second search based on the list including correct model data;
displaying a window on the web page order a second list of respective correct model data based on the second search, said second list listing a subset of the correct model data listed on the first list; and
providing a respective hyperlink with each respective model data included in the second list so that upon any respective hyperlink being clicked by the purchaser, the data field in the web page order is filled with the correct model data corresponding to that hyperlink.

23. The web-enabled method of claim 22 wherein the listed model data is classifiable based on a respective product line.

24. The web-enabled method of claim 22 wherein the listed model data further includes product availability.

25. The web-enabled method of claim 24 wherein the listed model data further includes one or more product attributes.
